(19) United States
(12) Patent Application Publication
(10) Pub. No.: US 2009/0153416 A1
(43) Pub. Date: Jun. 18, 2009

(54) METAL COVER FOR A RADIO COMMUNICATION DEVICE

(75) Inventors: Axel von Arbin, Täby (SE); Peter Lindberg, Uppsala (SE); Ermin Pasalle, Akersberga (SE); Andrei Kaikkonen, Jarfalla (SE)

Correspondence Address: HOLLAND & HART, LLP, P.O BOX 8749, DENVER, CO, 80201, US

(73) Assignee: Laird Technologies AB, Akersberga (SE)

(21) Appl. No.: 12/159,346

(22) PCT Filed: May 16, 2007
(86) PCT No.: PCT/SE2007/000479

§ 371 Date: Nov. 3, 2008

(30) Foreign Application Priority Data
May 19, 2006 (EP) 06445026.5

(51) Int. Cl. H01Q 1/24

(52) U.S. Cl. 343/702

(57) ABSTRACT

The present invention relates to a metal cover (1) for a radio communication device. The metal cover (1) comprises a through non-conductive hole forming a slot (4; 10) through the metal cover (1), and a radio frequency feed (6, 7; 8, 9), wherein the radio frequency feed (6, 7; 8, 9) is arranged across the slot (4; 10) to feed the slot (4; 10) as a slot antenna for the radio communication device.

### FIELD OF INVENTION

The present invention relates generally to covers for radio communication devices, and particularly to metal covers for radio communication devices.

### BACKGROUND

A current trend for portable radio communication devices, such as mobile phones, PDA, portable computers and similar devices, is to provide the device with a metal cover. A metal cover for a portable radio communication device makes it difficult to provide the device with a non-protruding antenna, as the metal cover shields the inner of the device for radio frequencies. It is possible to only partly provide the cover as a metal cover, to allow the use of a built in antenna, but it would be desirable to provide a full metal cover.

Another trend for portable radio communication devices, such as mobile phones and similar devices, is to provide the device with a very broadband coverage, covering e.g. GSM850, GSM900, GSM1800, GSM1900, UMTS 2100 MHz, and WLAN 2.4 GHz. This puts further restrictions on the design of an antenna for a portable radio communication device.

### SUMMARY OF THE INVENTION

An object of the present invention is to provide a metal cover for a radio communication device.

Another object of the present invention is to provide a radio communication device having a metal cover.

These objects, among others, are according to the present invention attained by a metal cover and a radio communication device, respectively, as defined by the appended claims.

By providing a metal cover with a through non-conductive hole in the shape of a slot a radio communication device, such as a mobile phone, can be provided with a full metal cover having a non-protruding antenna.

By providing the metal cover with a through non-conductive hole in the shape of an open-ended slot a broadband coverage can be attained.

Although the present invention is particularly useful for portable radio communication devices, it is also applicable to fixed radio communication devices such as base stations. Further features and advantages of the present invention will be evident from the following description.

### BRIEF DESCRIPTION OF THE DRAWINGS

The present invention will become more fully understood from the detailed description of embodiments given below and the accompanying figures, which are given by way of illustration only, and thus, are not limitative of the present invention, wherein:

FIG. 1 schematically shows a cover for a mobile phone;

FIG. 2 schematically shows a cover having a through non-conductive hole in the shape of a slot according to a first embodiment of the present invention;

FIGS. 3 and 4, schematically shows radio frequency feeding of a slot antenna; and

FIG. 5 schematically shows a cover having a through hole in the shape of a slot according to a second embodiment of the present invention.

### DETAILED DESCRIPTION OF EMBODIMENTS

In the following description, for purpose of explanation and not limitation, specific details are set forth, such as particular techniques and applications in order to provide a thorough understanding of the present invention. However, it will be apparent for a person skilled in the art that the present invention may be practiced in other embodiments that depart from these specific details. In other instances, detailed description of well-known methods and apparatuses are omitted so as not to obscure the description of the present invention with unnecessary details.

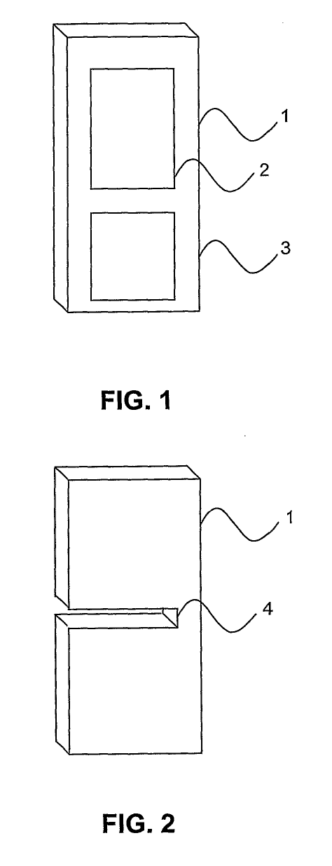

A first embodiment of the present invention will now be described with reference to FIGS. 1-4.

A portable radio communication device, such as a mobile phone, has a metal cover 1, a display 2 mounted in the metal cover 1, and a key pad 3 also mounted in the metal cover 1. Components for operation of the portable radio communication device is as usually provided within its housing, i.e. in this case within the metal cover 1.

The metal cover 1 is further provided with a through non-conductive hole in the shape of a slot 4. The slot 4 is in turn provided with a radio frequency feed arranged across the slot 4 to feed the slot 4 as a slot antenna for the portable radio communication device. The portable radio communication device should not be provided with a ground plane in the slot 4, which presence significantly would deteriorate the antenna functionality of the slot antenna. In order for the slot antenna to function adequately the metal cover is preferably made up by or metallized by a good conductive material.

For a common size of about 100 mm×40 mm of the metal cover 1 it is possible to provide a frequency band of about 0.8-2.6 GHz. This can be achieved e.g. by providing a box-shaped metal cover 100 mm×40 mm having a thickness of 10 mm with an open ended slot 34 mm wide and 5.7 mm high positioned substantially in the middle of the metal cover, and providing feeding 12 mm from the open end of the slot. The depth of the metal cover 1 does not affect the antenna functionality noticeable, and a mobile phone can thus be made very slim, down to a single layer, considering the antenna properties.

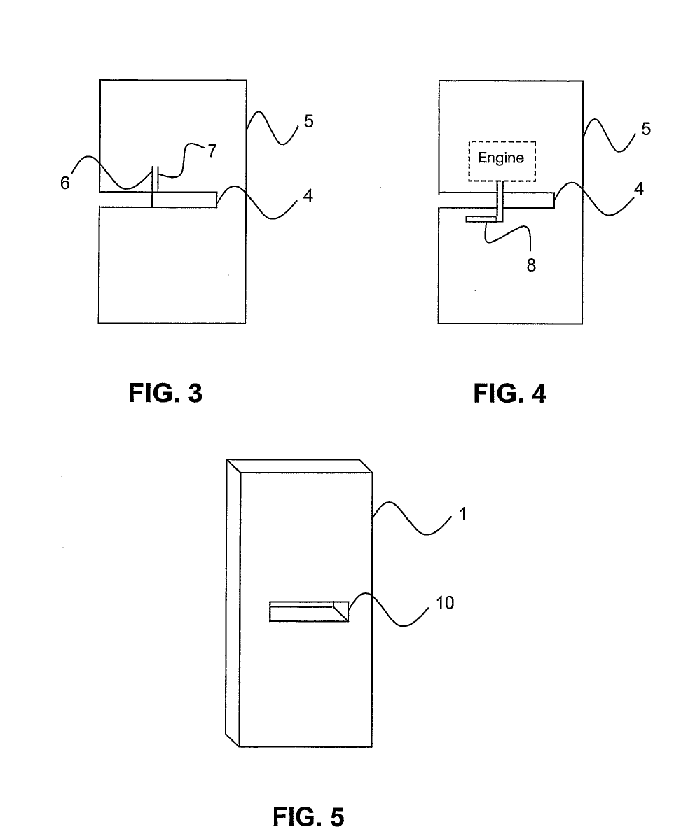

The radio frequency feed can be provided in a plurality of ways. A coaxial feed can e.g. be used for feeding the slot antenna, which is illustrated in FIG. 3, wherein grounding 7 of the coaxial feed is provided on one side of the slot 4 and feed 6 is provided on another side of the slot 4 essentially opposite the grounding 7. A micro strip feed 8 can also be used for feeding the slot antenna, which is illustrated in FIG. 4, wherein the micro strip feed further has a stub matching for tuning of the radio frequencies. Other possible feedings are e.g. planar feeding and feeding with lumped components.

By providing the slot 4 approximately in the middle of the metal cover 1 it is easiest to provide broadband coverage for the slot antenna, but by providing the slot 4 somewhat displaced from the middle of the metal cover 1 space is provided for a large display 2 for the mobile phone. The walls of the slot 4 are preferably provided as metal walls connected to the metal cover 1, but could also be provided as open walls, however open wall has the effect that coupling to box cavity modes of the metal cover will be very difficult to control.

A second embodiment of the present invention will next be described with reference to FIG. 5. This second embodiment of the present invention is similar to the first embodiment described above apart from that the slot 10 is not open ended. A drawback with a closed slot 10 compared to an open ended slot according to the first embodiment described above is that it is more difficult to provide lower frequencies for the closed slot antenna 10. An advantage is that wiring in the portable radio communication device is easier to provide with the closed slot antenna 10.

It will be obvious that the present invention may be varied in a plurality of ways. Such variations are not to be regarded as departure from the scope of the present invention. All such variations as would be obvious for a person skilled in the art are intended to be included within the scope of the present invention as defined by the appended claims. By a through non-conductive hole is meant a hole completely through the metal cover, possibly filled with non-conductive materials but no conductive parts leading into or past the slot-shaped hole, apart from feeding.

1. A metal cover (1) for a radio communication device, characterized in that said metal cover (I) comprises a through non-conductive hole forming a slot (4; 10) through said metal cover (1), and a radio frequency feed (6, 7; 8, 9), wherein said radio frequency feed (6, 7; 8, 9) is arranged across said slot (4; 10) to feed said slot (4; 10) as a slot antenna for said radio communication device.

2. The metal cover according to claim 1, wherein said slot (4) is an open-ended slot.

3. The metal cover according to claim 1, wherein said slot (4) is arranged in the middle of said metal cover (1).

4. The metal cover according to claim 1, wherein said slot (4) is arranged displaced from the middle of said metal cover (1).

5. The metal cover according to claim 1, wherein said radio frequency feed (6, 7; 8, 9) is provided as one of the following: coaxial feed, micro strip feed, planar feed, and feed with lumped components.

6. The metal cover according to claim 1, wherein said slot (4; 10) has metal walls.

7. The metal cover according to claim 1, wherein said metal cover is box-shaped.

8. The metal cover according to claim 1, wherein said slot antenna is arranged to cover GSM850, GSM900, GSM1800, GSM1900, UMTS 2100 Mhz and WLAN 2.4 GHz.

9. The metal cover according to claim 1, wherein said radio communication device is portable.

10. A radio communication device comprising a metal cover (1) characterized in that said metal cover (1) comprises a through non-conductive hole in the shape of a slot (4; 10) through said metal cover (1), and a radio frequency feed (6, 7; 8, 9), wherein said radio frequency feed (6, 7; 8, 9) is arranged across said slot (4; 10) to feed said slot (4; 10) as a slot antenna for said radio communication device.
